(19) United States
(12) Patent Application Publication
(10) Pub. No.: US 2023/0083888 A1
(43) Pub. Date: Mar. 16, 2023

(54) METHOD AND SYSTEM FOR AUTONOMOUS CALIBRATION/RECALIBRATION

(71) Applicant: AT&T Intellectual Property I, L.P., Atlanta, GA (US)

(72) Inventor: Eric Zavesky, Austin, TX (US)

(73) Assignee: AT&T Intellectual Property I, L.P., Atlanta, GA (US)

(21) Appl. No.: 17/471,405

(22) Filed: Sep. 10, 2021

(51) Int. Cl. G01M 99/00; H04L 29/08

(52) U.S. Cl. CPC G01M 99/005; H04L 67/12

(57) ABSTRACT

Aspects of the subject disclosure may include, for example, obtaining data provided by a sensor associated with an autonomous computer vision system (ACVS), based on the obtaining the data provided by the sensor, performing an analysis of the data relative to other data, wherein the other data comprises prior data provided by the sensor, different data provided by a different sensor associated with the ACVS, certain data provided by a central system communicatively coupled to the device, or a combination thereof, responsive to the performing the analysis of the data, determining whether a particular criterion associated with the data is satisfied, and performing an action relating to the sensor, the ACVS, or both, based on a determination that the particular criterion associated with the data is satisfied. Other embodiments are disclosed.

### FIELD OF THE DISCLOSURE

The subject disclosure relates to analyzing the performance of an autonomous computer vision system and/or associated sensor(s) over time, and facilitating calibration/recalibration/repair of the system and/or sensor(s) based on the analyzing.

### BACKGROUND

Many autonomous devices, such as vehicles (e.g., cars, boats, or the like), robot assistants, drones, etc., are equipped with computer vision systems for environmental awareness and navigation. As the number of computer vision systems in autonomous devices continues to grow, the care and feeding of these systems and associated sensors become increasingly important. While regular system maintenance might enable detection of critical errors, such maintenance is generally infrequent—e.g., performed only once or twice a year.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIGS. 2B-2D depict example, non-limiting implementations of the system of FIG. 2A in accordance with various aspects described herein.

FIG. 2E is a high-level functional block diagram of a system functioning within, or operatively overlaid upon, the communications network of FIG. 1 in accordance with various aspects described herein.

FIG. 2F depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for augmenting a computer vision system of an autonomous device by monitoring for sensor degradation or failure over time, and facilitating calibration/recalibration/repair of the system and/or sensor(s) to achieve optimal numerical precision.

In various embodiments, a computer vision system—e.g., an autonomous computer vision system (ACVS)—of a device may be configured to conduct partial, or full, self-monitoring and/or self-testing of associated sensors. The sensors may include one or more image sensors (e.g., cameras), one or more audio sensors (e.g., microphones), one or more temperature sensors, one or more humidity sensors, one or more biometric sensors, one or more haptic sensors (e.g., touch-based devices), and/or the like. The device may be an autonomous device, such as a vehicle (e.g., a car, a boat, or the like), a drone, a robot assistant, an Internet-of-Things (IoT) device, a similar type of device, a different type of device (e.g., an extended reality (XR) headset or related gear), or a combination of some or all of these devices. An autonomous computer vision system may encompass the sensors and sub-systems of other components of the device, such as warning lights, proximity sensors (e.g., sound-based proximity sensors), or the like. In certain device implementations, the sensors of the computer vision system may serve multiple functions. For example, for vehicles, such as cars, the sensors may be used for vehicle lane adherence purposes, proximity detection, obstacle detection, on-coming headlight detection, terrain and performance detection (e.g., pavement, grass, etc.), user recognition (e.g., face or other biometrics for “summon” functions), and/or the like. An autonomous computer vision system may be distinguishable from a non-autonomous computer vision system in that an autonomous computer vision system may include a combined network of sensors that formulate an “awareness” of location, state, or position of a device; may control certain systems, such as those relating to device movement, acceleration, and/or directional orientation; and/or may provide automation (e.g., full, partial, or guided) for accomplishing functional tasks, such as parking, navigation, and/or obstacle discerning. It is to be appreciated and understood that these distinguishing characteristics are a non-exhaustive example set of device behaviors that may expand as the role of autonomous devices evolves. Thus, the developing class of applicable devices/ACVS can broadly cover various classes of vehicles (e.g., cars, boats, or the like), consumer or industrial drones and/or robots, as well as devices oriented for individual usage (e.g., an XR headset used for immersive entertainment) and that utilize spatial positioning in a room or setting to perform obstacle detection and avoidance as part of their functionality—e.g., by utilizing spatial awareness from sensors to help subtly guide users away from obstacles in a room, such as by defining/executing a straight line path with small curvature and an arc to control user navigation.

Exemplary embodiments provide algorithmic-based functionality for the ACVS during device power-on and/or shutdown. In particular, the ACVS may be configured to perform monitoring/testing of sensor(s) during power-on and/or power-off of the device—e.g., as part of a power-on/-off self-test (POST) process or the like.

In exemplary embodiments, the ACVS may be configured to leverage or reuse a “common” or “fixed” environment—e.g., a docking, parking, charging, at-rest, or storage location or environment—of the autonomous device for monitoring and ascertaining sensor performance. In various embodiments, the ACVS may be configured to (e.g., over time) obtain/capture information regarding a fixed (e.g., stable, known, or constant) environment, construct/define/refine geometric model(s) of the environment, and utilize sensor measurements or readings pertaining to the environment to detect current (and/or predict future) sensor degradation or failure. In one or more embodiments, construction, defining, and/or refining of geometric model(s) can involve image/object recognition (e.g., three-dimensional (3D) imaging or scanning) techniques, and can be performed based on (e.g., during) parking/docking of the device at, and/or departure of the device from, the known or common area. Doing so enables the ACVS to “fingerprint” a particular environment over time, and allows for comparison of present sensor readings with prior measurement values and/or standard (or default) values as well as appropriate calibration testing and/or reporting of system/sensor issues. In various embodiments, sensor data comparisons can involve comparing data relating to a given sensor with known or historical data/settings (e.g., obtained/derived over time by the ACVS based on prior data relating to that sensor or one or more other sensors of the autonomous device; provided by a manufacturer/operator of the autonomous device or the fixed environment; or the like), comparing data relating to a given sensor with (e.g., present) data provided by one or more (e.g., an aggregate of) other sensors of the autonomous device (e.g., data from a front camera versus data from side and/or rear cameras, etc.), and/or comparing data relating to one or more sensors of the autonomous device with (e.g., present or historical) data relating to one or more sensors of other peer autonomous device(s). With minor variations, a well-explored environment (e.g., a parking location, such as a garage) would thus generally be constant, and an onboard ACVS can leverage this environment, or information regarding the environment, for calibration/recalibration of the ACVS and/or associated sensors.

In exemplary embodiments, the ACVS may be configured to (e.g., automatically) introduce variance into the environment for system/sensor testing. Variance can be introduced in any suitable manner, including by activating capabilities of the autonomous device or the ACVS, such as causing mechanical movements of the device or component(s) thereof, causing navigation of the device or component(s) thereof, effecting manipulation of lighting and/or sound output components (e.g., lamp(s), sonar unit(s), etc.), and/or the like. In various embodiments, the ACVS may be configured to introduce such variance condition(s), and monitor and compare sensor readings in the presence of such condition(s). This can provide additional data for system training and sensor reading validation. In this way, an autonomous device's capture/sensor components and actuator components can be utilized in tandem to support not only autonomy operations (e.g., driving, flying, etc.) but also system and/or sensor calibration/recalibration/repair.

In one or more embodiments, variances corresponding to different facets (e.g., time of day, duration of stay, in-motion process, detected lighting, etc.), for sensors individually or in the aggregate, can be determined or extracted, and used for training and/or ascertaining sensor performance. In various embodiments, variance can be computed or detected based on final spatial errors (e.g., determined geometry differences), detected input differences (e.g., due to smudge(s), a damaged sensor, etc.), and/or other conditions. In exemplary embodiments, the ACVS may employ one or more artificial intelligence (AI) models (e.g., machine learning model(s)) to pre-classify (e.g., each) detected change/type, identify sensor degradation/failure patterns, and/or determine appropriate calibration/recalibration/repair measures.

In exemplary embodiments, the ACVS may be configured to vet or compare sensor performance and/or computer vision system-related operations for an autonomous device against that of peer autonomous devices in other (e.g., similar) environments. For example, in one or more embodiments, an autonomous device may be included as part of a connected fleet of devices (e.g., operated or managed by an entity or manufacturer), where sensor modeling and performance may be centrally aggregated, and “personalization” models may be derived and respectively distributed to individual autonomous devices to address system/sensor degradations or failures. In this way, individual autonomous devices may provide sensor data as (e.g., only as) local inference models, where a central system or server may provide compute functionality for receiving sensor reports from the various devices, comparing the reports of the various devices to identify model drift(s) and/or mean times between failure (MTBF), and preemptively identifying potential system/sensor failure and/or appropriate calibration/recalibration/repair measures. Connected data can therefore be collected and used not in (e.g., not only in) the aggregate, but additionally, or alternatively, for individual ACVS customization and/or individual sensor performance optimization. In exemplary embodiments, the central system or server may provide preemptive anomaly detection/aggregation, where sensor-based errors or anomalies that are typical in a specific geographic region can be identified or discovered (e.g., over time), and made known to individual devices/ACVS operating in that region, such that false alarms can be prevented and/or appropriate remediation measures can be taken to adjust sensor behavior as needed.

POST/shutdown (power on/off self-test) operations can thus be adapted to perform rigorous, sensor-specific testing, calibration/recalibration, and reporting—e.g., autonomous recalibration for POST/shutdown operations. Exemplary embodiments of sensor-related calibrations/recalibrations—e.g., performed based on measurements obtained during device power-on or shutdown—can be applied in a variety of systems or operations, including, for example, charging stations, docking systems, enterprise and fleet storage/check-in operations, and/or the like. Embodiments described herein enable early detection of sensor degradation or failure in automated computer vision systems, thereby providing improved operational safety and system performance. Computer vision system or sensor self-testing and self-reporting, as described herein, also allows for potential expansion into certification or regulatory protocol(s), which can provide uniform standard(s) of operation for autonomous devices. Obtaining sensor-based data for an autonomous computer vision system also yields additional datapoints for local collection and enables 3D assessments against known environments.

One or more aspects of the subject disclosure include a device, comprising a processing system including a processor, and a memory that stores executable instructions that, when executed by the processing system, facilitate performance of operations. The operations can include obtaining data provided by a sensor associated with an autonomous computer vision system (ACVS). Further, the operations can include, based on the obtaining the data provided by the sensor, performing an analysis of the data relative to other data, wherein the other data comprises prior data provided by the sensor, different data provided by a different sensor associated with the ACVS, certain data provided by a central system communicatively coupled to the device, or a combination thereof. Further, the operations can include, responsive to the performing the analysis of the data, determining whether a particular criterion associated with the data is satisfied. Further, the operations can include performing an action relating to the sensor, the ACVS, or both, based on a determination that the particular criterion associated with the data is satisfied.

One or more aspects of the subject disclosure include a non-transitory machine-readable medium, comprising executable instructions that, when executed by a processing system including a processor, facilitate performance of operations. The operations can include obtaining, over a communications network, a set of data associated with various sensors of a plurality of autonomous devices in a fleet of autonomous devices. Further, the operations can include receiving, over the communications network, particular data associated with a first sensor of a first autonomous device in the fleet of autonomous devices, wherein the first autonomous device is not included in the plurality of autonomous devices. Further, the operations can include comparing the set of data and the particular data to identify a deviation that satisfies a threshold. Further, the operations can include generating calibration information based on identifying a deviation that satisfies the threshold. Further, the operations can include transmitting the calibration information to the first autonomous device for calibrating or recalibrating the first sensor.

One or more aspects of the subject disclosure include a method. The method can comprise receiving, by a processing system including a processor, data from a sensor of an autonomous device, wherein the autonomous device comprises a computer vision system. Further, the method can include, responsive to the receiving the data, generating, by the processing system, a first geometric model based on the data from the sensor. Further, the method can include performing, by the processing system, a comparison of the first geometric model and a second geometric model generated based on different data. Further, the method can include, based on the performing the comparison of the first geometric model and the second geometric model, determining, by the processing system, that a threshold difference, between a first portion of the first geometric model and a second portion of the second geometric model, is satisfied. Further, the method can include causing, by the processing system, an action relating to the sensor or the computer vision system to be performed based on the determining that the threshold difference is satisfied.

Other embodiments are described in the subject disclosure.

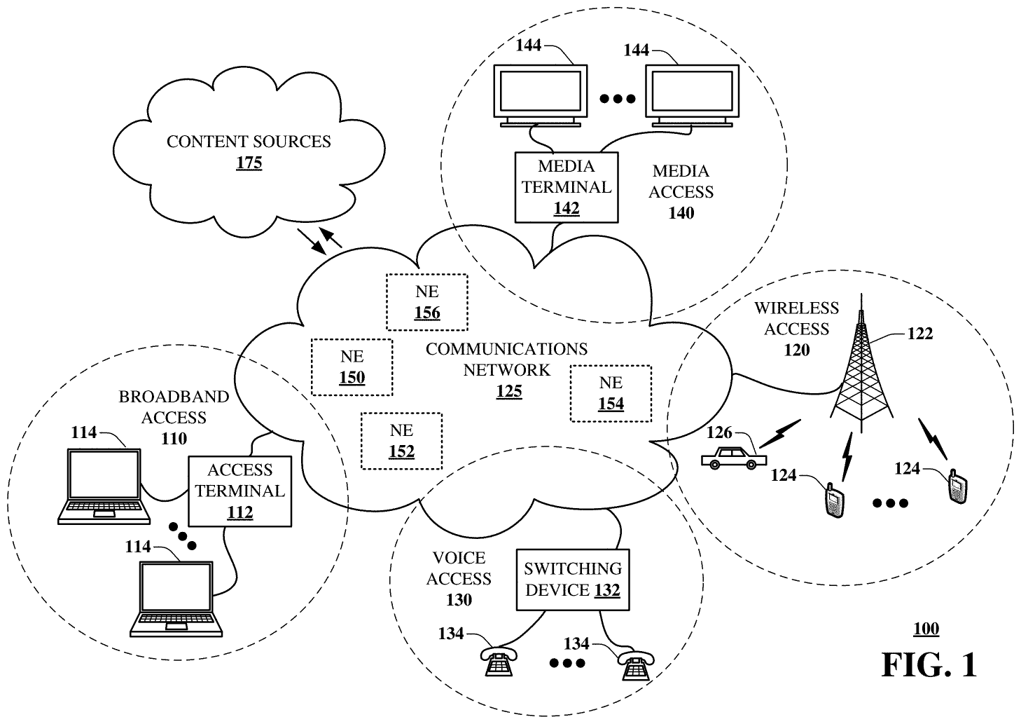

Referring now to FIG. 1, a block diagram is shown illustrating an example, non-limiting embodiment of a system 100 in accordance with various aspects described herein. For example, system 100 can facilitate, in whole or in part, analysis of the performance of an autonomous computer vision system and/or associated sensor(s) over time, and facilitating calibration/recalibration/repair of the system and/or sensor(s) based on the analysis. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

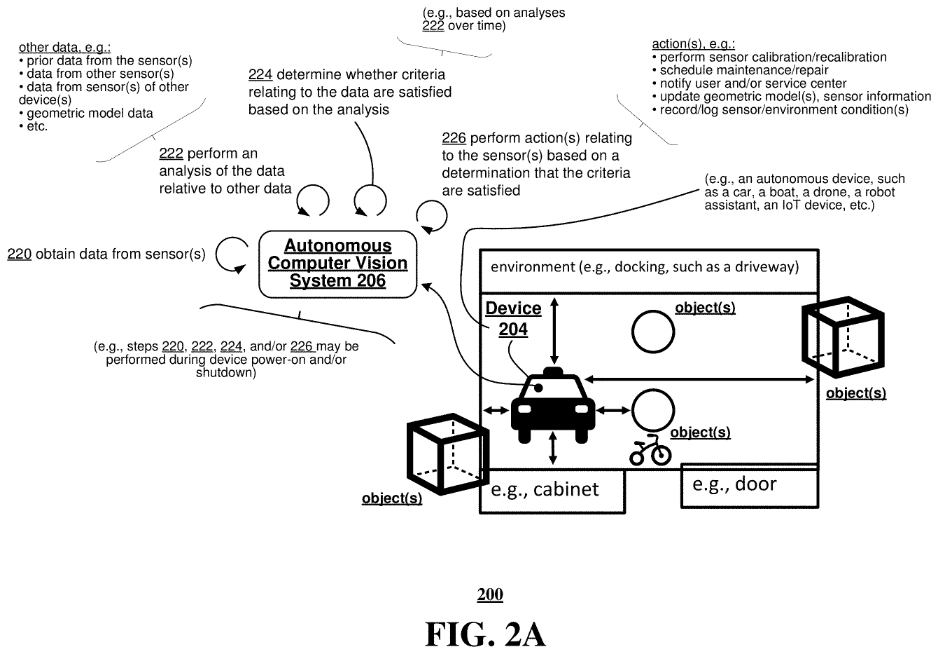

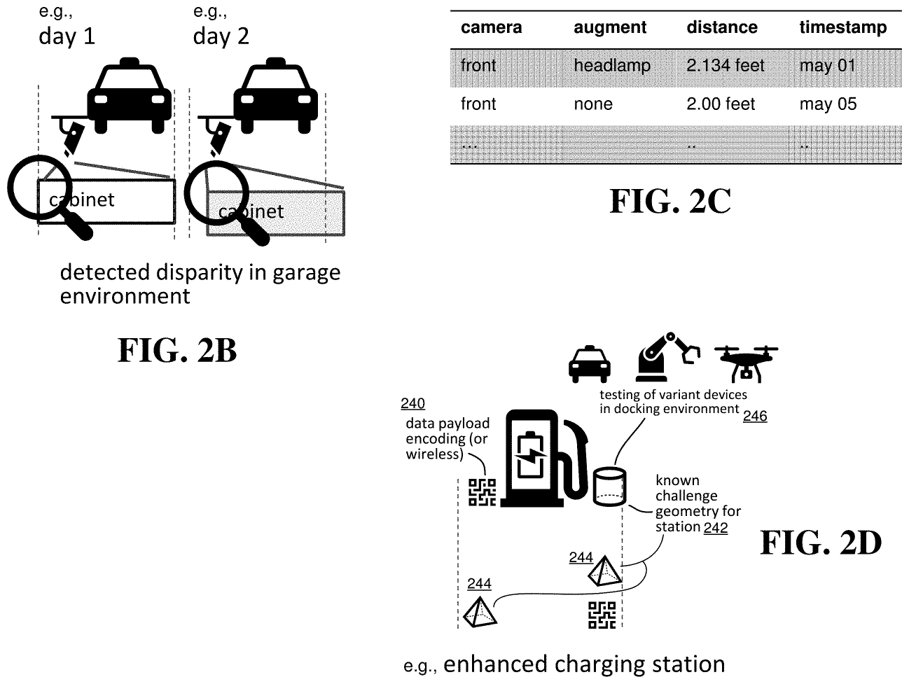

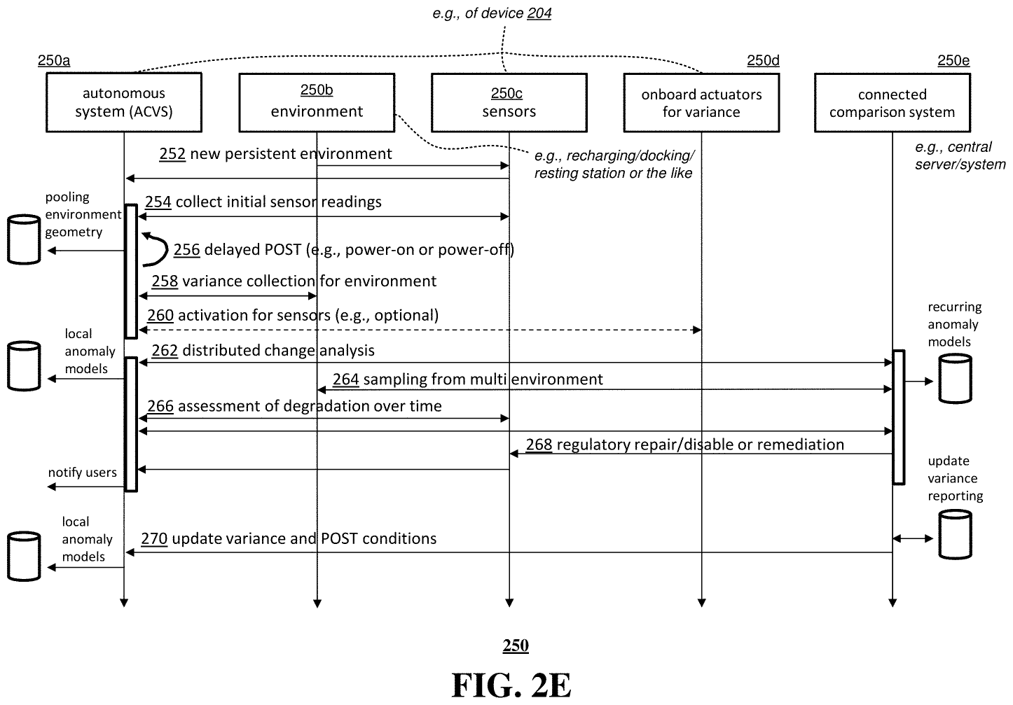

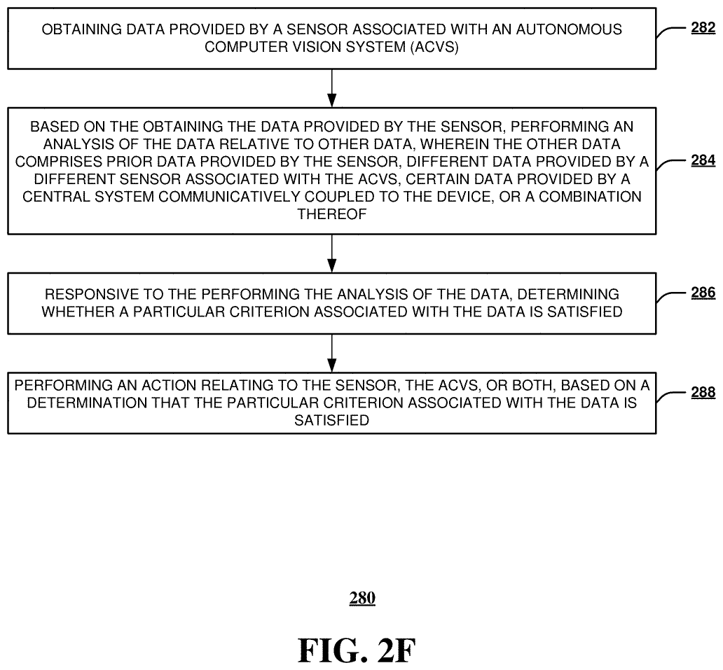

FIG. 2A is a block diagram illustrating an example, non-limiting embodiment of a system 200 functioning within, or operatively overlaid upon, the communications network 100 of FIG. 1 in accordance with various aspects described herein.

As shown in FIG. 2A, the system 200 can include a device 204. The device 204 can be an autonomous device, such as a vehicle (e.g., a car—as shown in FIG. 2A, a boat, or the like), a drone, a robot assistant, an IoT device, a similar type of device, a different type of device (e.g., an XR headset or related gear), or a combination of some or all of these devices. In exemplary embodiments, the device 204 can include an ACVS 206 and one or more associated sensors. The sensor(s) can include one or more image sensors (e.g., cameras), one or more audio sensors (e.g., microphones), one or more temperature sensors, one or more humidity sensors, one or more biometric sensors, one or more haptic sensors (e.g., touch-based devices), and/or the like.

In certain embodiments, the device 204 may be included as part of a set or fleet of devices 204 (not shown). For example, in some embodiments, the device 204 and/or the ACVS 206 may be communicatively coupled to a central server—e.g., via a network (not shown)—configured to communicate with, and obtain data from, multiple devices 204. The network may include one or more wired and/or wireless networks. For example, the network may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

In various embodiments, the ACVS 206 may be configured to provide one or more functions or capabilities relating to sensor data analysis and comparison and system/sensor calibration/recalibration control. In exemplary embodiments, the ACVS 206 may perform one or more of steps 220, 222, 224, and 226 (described in more detail below) during a shutdown operation of the device 204 and/or during power-on (e.g., during a power-on self-test (POST) operation or the like) of the device 204. Delayed shutdown (e.g., where the ACVS 206 operates for a predefined amount of time, such as N seconds, prior to complete shutdown) and power-on phases may be optimal times for sensor testing and calibration/recalibration, given that uncontrollable variances (e.g., user-induced movements of the device 204, environmentally-induced movements of the device 204, etc.) are generally at a minimum during these times. It is to be appreciated and understood that the ACVS 206 may additionally, or alternatively, be configured to perform any of steps 220, 222, 224, and 226 at other times during operation of the device 204.

In various embodiments, the ACVS 206 may be configured to identify or detect a (e.g., new) persistent environment, which may be a “common” or “fixed” environment—e.g., a docking, parking, charging, at-rest, or storage location or environment—of the device 204. In one or more embodiments, the ACVS 206 may initially detect the environment or location as part of an initial power-on and/or a first shutdown, based on user instruction, by default, and/or the like, and may mark the environment or location as a (e.g., potential) ACVS POST calibration/recalibration point. The ACVS 206 may detect a presence/recurrence of the environment in any suitable manner, such as by detecting a location of the device (e.g., via cell positioning and/or via navigation techniques, such as detection of global positioning system (GPS) coordinates, etc.), by detecting physical features associated with the environment (e.g., via image/object recognition), and/or the like. The ACVS 206 may, based upon subsequent detection of the environment, identify that the device 204 is located at a recalibration station or location, and trigger (or initiate) obtaining of data provided by sensor(s), analysis/comparison of the sensor data, identifying of needed calibrations/recalibrations, and/or the like, as described herein.

In various embodiments, the ACVS 206 may collect initial sensor readings for the environment. This may involve local collection of sensed geometry or geometric features in an area of the environment (e.g., for a certain amount of space about the environment), such as the geometry of physical structures in the environment within a threshold distance from the device 204 and/or the various sensors. In certain embodiments, the ACVS 206 may additionally, or alternatively, obtain a predefined model of the environment (e.g., a 3D model of the environment, such as a 3D scan of a docking station, a garage, etc.). In one or more embodiments, ACVS 206 may determine, or otherwise coordinate, spatial geometry for the environment based on (e.g., by rationalizing) data provided by all sensors (e.g., all cameras, etc.) and/or based on data provided by each sensor (e.g., each camera, etc.). The latter may be useful for subsequent testing/re-testing of each sensor of the system.

As shown by reference number 220, the ACVS 206 may obtain data provided by one or more sensors of the device 204. In various embodiments, the ACVS 206 may perform step 220 at any point after the above-described initial identification or detection of the fixed environment. Here, the ACVS 206 may, similar to the above-described collection of initial sensor readings for the environment, obtain, from the sensor(s), data relating to the geometry of structural features in an area of the environment.

As shown by reference number 222, the ACVS 206 may perform an analysis of the data relative to other data. In one or more embodiments, the ACVS 206 may perform the analysis by comparing the data with other data. In exemplary embodiments, the other data may include data previously obtained from the one or more sensors (e.g., historical data obtained during one or more prior performances of step 220, such as during start-up(s) and/or shutdown(s)), data provided by other sensor(s) of the device 204 (e.g., presently provided and/or provided during one or more prior performances of step 220), data provided by sensor(s) of other devices (e.g., other devices 204 or the like), and/or data relating to a model (e.g., model data for the environment, such as geometric model data or the like).

In one or more embodiments, the ACVS 206 may, based upon obtaining data from one, some, or all sensors of the device 204, determine, or otherwise coordinate, spatial geometry for the environment, and perform a comparison of the spatial geometry with prior-determined spatial geometry. Prior-determined spatial geometry can include spatial geometry determined based on one or more prior performances of step 220 and/or based on the above-described initial collection of sensor data and determination of environmental spatial geometry. In various embodiments, the ACVS 206 may compare spatial geometry—e.g., regarding an object or the environment—determined based on data provided by a first sensor of the device 204 relative to spatial geometry (e.g., regarding the object or environment) determined based on prior data provided by the first sensor, determined based on data provided by one or more other sensors of the device 204, and/or determined based on data provided by one or more sensors of peer device(s) 204. As another example, the ACVS 206 may compare spatial geometry—e.g., regarding an object or the environment—determined based on data provided by one or more sensors of the device 204 relative to a predefined, spatial geometry model (e.g., for the object or environment) provided by a manufacturer/operator of the autonomous device or the fixed environment.

In cases where the above-described comparison is against a predefined model of the environment (e.g., a default 3D model of the environment, such as a 3D scan of a docking station, a garage, etc.), the concept of persistence may or may not apply. In these cases, the ACVS 206 may determine sensor performance based on conformance of sensor data to the predefined model—e.g., conformance of data for a given sensor to a predefined model corresponding to that sensor and/or conformance of aggregate data for multiple (or all) sensors to a predefined aggregate model corresponding to multiple (or all) sensors.

In some cases, the ACVS 206 may (e.g., during power-on or shutdown) detect or encounter a new, or previously-unknown, geometric structure, such as, for example, a new art sculpture placed near a docking station or the like. In various embodiments, the ACVS 206 may, upon being repeatedly being exposed to the geometric structure and obtaining data from various sensors pertaining to the structure over time, generate a geometric model of the structure and utilize the model as part of testing sensor performance.

As shown by reference number 224, the ACVS 206 may determine whether criteria relating to the data are satisfied based on the analysis. In various embodiments, the criteria may include difference(s) between the obtained data and the other data satisfying one or more thresholds, such as a difference between a spatial distance or dimension represented by the obtained data and a spatial distance or dimension represented by the other data exceeding a threshold distance or dimension. Identifying deviations from historical or known data (e.g., as shown in FIG. 2B) enables the ACVS 206 to decide on remediating steps to address potential sensor performance degradation or failure. In various embodiments, the ACVS 206 may continuously generate and/or update 3D models of an environment (e.g., corners of tables, poles, objects (such as bikes, tools, etc.), and/or the like). In a case where the ACVS 206 detects a spike in sensor reading(s) or detects sensor reading(s) that suggest the presence of an unknown structure, such as, for example, a cone-like shape rather than a known rectangular table, the ACVS 206 may determine a need for system or sensor calibration/recalibration/repair.

In certain embodiments, the criteria may include time-based criteria. As an example, the ACVS 206 may distinguish first deviation(s) in sensor readings (e.g., persistent deviation(s) or change(s) from prior/known value(s)) during a first year of operation of the device 204 from second deviation(s) during a shorter period of time (e.g., the past three months, the past several weeks, or the like). For instance, the ACVS 206 may identify the first deviation(s) as being acceptable or normal (e.g., if the first deviation(s) are within certain threshold(s)), and may identify the second deviation(s) as being indicative of an anomaly, sensor damage, sensor drift, or occlusion (e.g., if the second deviation(s) surpass certain threshold(s)).

In one or more embodiments, variances corresponding to different facets (e.g., time of day, duration of stay, in-motion process, detected lighting, etc.), for sensors individually or in the aggregate, can be determined or extracted, and used for ACVS training and/or ascertaining sensor performance. For example, in the case of time of day, the ACVS 206 may obtain data from sensor(s) at different times of a day (e.g., morning, afternoon, or evening), where temperature, lighting conditions, and/or other environmental conditions may be different.

In exemplary embodiments, the ACVS 206 may be configured to (e.g., automatically) introduce variance into the environment for sensor testing. In various embodiments, the ACVS 206 may be configured to manipulate one or more components (e.g., actuators, such as light(s), motor(s), etc.) to introduce variance condition(s), and monitor and compare sensor readings in the presence of such condition(s). This can provide additional data for system training and sensor reading validation.

In some embodiments, the ACVS 206 may be configured to actuate one or more headlights (e.g., a white headlight of a vehicle, a red taillight of the vehicle, etc.) of the device 204 to introduce different red-green-blue (RGB) values and/or shadow effects in the environment, which may cause one or more sensors to operate differently and thus provide different data (e.g., as shown in FIG. 2C). As an example, assume that the device 204 includes an autonomous car with right and left headlights, and that the ACVS 206 obtains first data relating to (e.g., provided by) particular sensors of the device 204 while neither the right nor left headlight is activated. Continuing the example, the ACVS 206 may (e.g., automatically, prior to or as part of performing step 220) cause the right and/or left headlight to be activated to create diverse conditions for the sensors. Here, the ACVS 206 may, upon causing the right and/or headlight to be activated, similarly obtain second data relating to (e.g., provided by) one, some, or all of the particular sensors, and may correlate or compare the first and second data to detect anomalous condition(s). For instance, where the activated lighting creates a shadow that causes the second data to deviate (or “disagree”) with the first data, the ACVS 206 may determine a need for sensor calibration/recalibration/repair. It is to be appreciated and understood that the ACVS 206 may employ various combinations of lighting manipulations to calibrate/recalibrate sensors, which facilitates training of the ACVS 206 (including, for example, addressing of inefficiencies of the ACVS 206) such that the ACVS 206 can operate in different, real-world lighting conditions—e.g., in a sunrise condition, in a sunset condition, in the presence of high or low beams from other devices, and/or in the presence of other light emission/reflection conditions.

In certain embodiments, the ACVS 206 may additionally, or alternatively, be configured to displace one or more movable units of the device (e.g., a mechanical arm of a drone or the like) and/or one or more nearby remotely-controllable components (e.g., a garage door, etc.) to introduce different lighting and/or shadow effects, which may similarly cause sensors to operate differently and thus provide different data. As an example, the ACVS 206 may (e.g., automatically, prior to or as part of performing step 220) cause the device 204 to displace or move in a certain manner as part of a docking operation at shutdown (e.g., prior to docking, during docking, or after docking) and/or as part of an undocking operation at start-up (e.g., prior to undocking, during undocking, or after undocking), and obtain first data from particular sensors of the device 204 when the device 204 is in a first position or orientation. Continuing the example, the ACVS 206 may cause the device 204 to displace or move in a certain manner, such as by a certain amount in a certain direction (e.g., forward, backward, left, right, up, down, in roll, in pitch, or in yaw). Here, the ACVS 206 may, with the device 204 in a second position or orientation in accordance with the displacement by the certain amount in the certain direction (e.g., such as 10 centimeters (cm) west), similarly obtain second data from one, some, or all of the particular sensors, and correlate or compare the first and second data to detect anomalous condition(s). For instance, where sensor (e.g., camera) depth or computer vision system-determined information does not reflect the physical change or difference in position/orientation, the ACVS 206 may determine a need for sensor calibration/recalibration/repair.

In one or more embodiments, and in a case where the device 204 includes movable lighting devices (e.g., headlights or the like) and/or movable sensors, the ACVS 206 may additionally, or alternatively, be configured to cause the lighting devices and/or the sensors to displace or move (e.g., linearly and/or angularly), similarly obtain different first and second data from the sensor(s) for comparison based on the displacement/movement, and correlate or compare the first and second data to detect anomalous condition(s).

In certain embodiments, the ACVS 206 may perform sensor readings and sensor data comparisons during normal operations of the device—e.g., outside of power-on or shutdown phases. For example, in a case where the device 204 includes an autonomous vehicle that is known (e.g., by the ACVS 206) to drive into a garage for parking, and where the garage includes a certain geometric structure (such as a wall or the like), the ACVS 206 may obtain, from respective sensors of the vehicle (e.g., a front sensor, a side sensor, and a rear sensor), data corresponding to the geometric structure, and compare the obtained data amongst one another to identify any discrepancies. For instance, where data obtained from a front sensor and data obtained from a side sensor both indicate that the geometric structure is about four feet long, but data obtained from the rear sensor indicates that the geometric structure is only about two feet long, the ACVS 206 may determine a need for sensor calibration/recalibration/repair (e.g., of the rear sensor).

In various embodiments, and regardless of the particular variance condition, the ACVS 206 may compute or detect variance in sensor data based on determined spatial differences or errors (e.g., geometry differences in distance and/or size). In one or more embodiments, changes or deviations in sensor readings may be measured for individual sensors (e.g., different data obtained from a single sensor or data obtained from different sensors) and/or for an aggregation of sensors, may be measured based on ACVS data, and/or may be measured or determined over time (e.g., over multiple or repeated exposures to the environment or geometric features thereof). In exemplary embodiments, the ACVS 206 may employ one or more artificial intelligence (AI) models (e.g., machine learning model(s)) to perform sensor data aggregation and/or pre-classify (e.g., each) detected change/type, and determine variances over time. In certain embodiments, the ACVS 206 may generate time-based and/or space-based models for detecting normal or typical anomalies (e.g., for distinguishing between lighting variance versus sensor damage).

In various embodiments, an environment, such as a docking station, recharging station, resting station, etc., for the device 204 may include “challenge” markers (e.g., visual markers) and/or structural objects, such as additional paint, movable actuators, etc. (including, for example, those that might have complex geometries), positioned at various locations in the environment. In these embodiments, the markers and/or objects can be detected by sensors of the device 204 for purposes of sensor data analysis/comparison and system or sensor calibration/recalibration/repair. As one example, a car, a drone, a robotic vacuum, or other (e.g., small) autonomous mobile device may recharge at a docking station. Here, “challenge” object(s) or marker(s) may be physically placed about the docking station (e.g., within threshold distance(s) from a portion of the docking station) to enable detection by sensor(s) of the device. A marker may, when detected or scanned by the device (e.g., as shown by example quick response (QR) code 240), facilitate downloading (e.g., reference number 242 in FIG. 2D), to the device, of geometric model(s) of objects at or proximate to (e.g., within a threshold distance from) the docking station. Examples of such object(s) are shown by reference numbers 244 of FIG. 2D. In various embodiments, instructions for introducing variance for sensor testing/calibration/recalibration (e.g., as shown by reference numbers 246 in FIG. 2D) may additionally, or alternatively, be downloaded or provided to the device. Markers may be predefined (e.g., by a manufacturer, vendor, or provider of the device 204 and/or a recharging/docking/resting station) as intentionally-introduced calibration/recalibration points for system self-assessment, which can be conducted in tandem with other operations of the ACVS 206. Markers may additionally, or alternatively, include unique environmental markers in the surroundings, such as trees on a sidewalk, paintings on one or more walls, etc. at different distances from the device 204 and/or its sensor(s) (e.g., different sensor depths), which can aid varied depth tests of the sensors and/or the ACVS 206.

In some embodiments, the ACVS 206 may be configured to perform manipulation tests for mechanical calibration/recalibration purposes. For instance, in these embodiments, a device 204 (e.g., a drone or the like) may include one or more mechanical arms/legs (e.g., controllable via brushed/brushless servo motor(s)), which the ACVS 206 may cause to move (e.g., in a certain direction and by a certain amount) in order to provide variance for mechanical movement testing/calibration/recalibration. In certain embodiments, the ACVS 206 and/or another system of the device 204 may leverage the ACVS 206 and associated sensor(s) to determine whether a commanded amount of movement of a mechanical component corresponds to (e.g., is within a threshold of) an actual/detected amount of movement (e.g., as detected by sensor reading(s)).

In one or more embodiments, the device 204 may be included as part of a connected fleet of devices 204 operably coupled to a central server/system (e.g., operated by an entity or manufacturer), where sensor modeling and performance may be centrally aggregated. In these embodiments, the central server/system may transmit payload(s)— e.g., provided by vendors of fleets with commercial recharging stations or the like—to the device 204. The ACVS 206 may utilize the payload(s) to validate the geometry of the environment (e.g., the docking station) and/or to identify the expected performance of sensor(s), including by taking into account the device type (e.g., a type of autonomous vehicle), sensor type, and/or docking station type. In certain embodiments, the central server/system may derive “personalization” models and respectively distribute the personalization models to individual devices 204 to address sensor degradations and/or failures thereat.

In various embodiments, the central server/system may have access to information based on learnings from sensor data/performance relating to devices operating in certain geographic regions characterized by particular environmental conditions (e.g., high temperatures, low temperatures, high air pressure conditions, low air pressure conditions, icy conditions, dry conditions, humid conditions, windy conditions, dirt road conditions, paved road conditions, etc.). In these embodiments, the central server/system may utilize such information (and/or may provide such information to the device 204) to determine whether detected sensor data anomalies or changes to 3D geometric models generated from such data are valid or to be expected, whether identified calibration/recalibration parameters need to be applied, etc. This can enable the central server/system and/or the ACVS 206 to avoid identifying sensor data (or geometric model) deviations as possible sensor degradation/failure in a case where the device 204 is determined to be located in a certain geographic region in which sensor(s) are known to be affected in certain way(s).

As shown by reference number 226, the ACVS 206 may perform action(s) relating to the sensor(s) based on a determination that the criteria are satisfied. In various embodiments, the action(s) may include (e.g., automatically) causing a notification to be provided to a user (e.g., visually, such as by flashing a light; audibly, such as by outputting a sound; haptically, such as by vibrating a portion of the device 204; and/or the like). In one or more embodiments, the ACVS 206 may cause the notification to be provided during a power-on or shutdown operation. In some embodiments, the action(s) may include (e.g., automatically) performing a self-assessment or self-adjustment for sensor degradation or failure, such as determining calibration/recalibration parameters and performing calibration/recalibration of affected sensor(s), disabling one or more functionalities of the ACVS 206 (e.g., prohibiting full autonomous driving of the device 204), and/or the like. In certain embodiments, the action(s) may include (e.g., automatically) scheduling for repair of the device 204 and/or the affected sensor(s) by contacting or coordinating with a manufacturer of the device 204 and/or an authorized third-party support/parts provider. In one or more embodiments, the ACVS 206 may provide (e.g., complete) diagnostic information regarding sensor degradation or failure (e.g., datapoints or sensor readings, deviation values, etc.) to facilitate determination of the appropriate remediation measures, such as part replacement and/or repair. In various embodiments, the ACVS 206 may facilitate calibration/recalibration, ordering of replacement part(s), and/or scheduling of maintenance/repair of the device 204, ACVS 206, associated sensor(s), etc. with minimal to no user intervention.

In various embodiments, the ACVS 206 may store information regarding sensor data deviations, identified sensor degradation/drift/failure, mitigations performed to address identified sensor degradation/drift/failure, changes/updates to models (e.g., geometric models) of environment(s)/object(s), and/or the like. The ACVS 206 may store the information (e.g., internally hash the information) locally in memory of the device 204. The ACVS 206 may additionally, or alternatively, provide (e.g., push) the information to a connected server or storage system, such as that operated by a manufacturer of the device 204 and/or an authorized third-party support/parts provider. In one or more embodiments, the ACVS 206 may provide an interface (e.g., an application programming interface (API) or the like) that allows a user, a remote system, or the like to access the information, which permits external “check-ins” on sensor drifts, capabilities, and performance. Such an interface can also enable civil authorities to obtain sensor data/mesh objects data to ascertain sensor performance, recent sensor calibration/recalibration according to certain performance standards, etc., which can facilitate determination of fault, negligence, etc. (e.g., in the event of an accident or a potential criminal act).

In cases where the ACVS 206 has access to a central server/system (e.g., a calibration/recalibration station), including, for example, one-way network communication access via which captured/identified geometric model data can be provided to the central system, communication of such data to the central system can enable sensor quality testing and device rating/certification for regulatory purposes. For instance, the central system can rate/report regulatory violations based on the data, and assign/publish a qualification/safety rating for the device 204 for operation in various environments. As an example, the central system can rate an autonomous car for operation on certain roads but not others, for operation by users of a certain qualification/skill level but not others, for operation under certain conditions but not others, and so on. As another example, the central system can rate a robot assistant for operation in certain buildings or settings but not others, or can rate a small IoT device for operation in narrow areas, etc.

In various embodiments, such as where the device 204 is included as part of a connected fleet of devices 204, an operator of the fleet may provide or utilize calibration/recalibration configurations/centers at various geographic locations for device maintenance purposes. The calibration/recalibration configuration/center may analyze/feed logistics system(s) and/or conduct loss-of-quality detection operations. In exemplary embodiments, the calibration/recalibration configuration/center may be designed to facilitate (e.g., rigorous) sensor-based maintenance that complements other regular maintenance operations. For instance, in certain embodiments, the calibration/recalibration configuration/center may include movable structures (e.g., walls or other objects), actuatable lighting devices, actuatable audio devices, and/or the like that a maintenance operator or tester (e.g., a user and/or an automated maintenance system) may selectively control, or otherwise manipulate, as part of testing the ACVS 206 and/or the associated sensors. A qualification/safety rating (e.g., similar to that described above) can be derived based on inspection results from such maintenance/testing.

In exemplary embodiments, such as where the device 204 is included as part of a connected fleet of devices 204 operably coupled to a central server/system, the ACVS 206 may be configured to vet or compare sensor performance and/or ACVS operations for the device 204 against that of peer devices. In various embodiments, step 224 can involve determining variance of sensor readings relative to sensor readings provided by peer devices. In one or more embodiments, the ACVS 206 may compare, or cause the central server/system to compare device 204's sensor readings to sensor readings of peer device(s) that are operating in other (e.g., similar) environments, such as a similar or same garage, a similar or same parking structure, a similar or same recharging station, and/or the like. In one or more embodiments, the ACVS 206 may compare, or cause the central server/system to compare, sensor readings based on sensor type (e.g., comparing data for sensors that are of the same or similar type), based on ACVS model or type (e.g., comparing data for other computer vision systems that are of the same or similar type), based on device type (e.g., comparing data for autonomous vehicles that are of the same or similar type), and/or generally across a fleet of enterprise devices.

In various embodiments, an operator of the fleet may provide or utilize training configurations/centers for object detection or navigation training purposes. Here, a training configuration/center may be equipped with various structural features (e.g., bumps, 3D objects of various shapes, combinations of shapes, and/or sizes, etc.) that may serve no purpose other than to train sensors of devices 204 for real-world (or in-field) operation and calibration/recalibration. In this way, the ACVS 206 can be trained to generate appropriate geometric models based on sensor readings and/or perform appropriate comparison/validation of geometric models against prior data or default data. One or more AI (e.g., machine learning) algorithms can be employed to facilitate the training process.

Accordingly, embodiments of the ACVS 206 can provide fully-automated calibration/recalibration and testing of the ACVS 206 and/or associated sensors. A common “resting” state can be leveraged to “capture” and “reuse” environment parameters for automatic testing of the ACVS and/or associated sensors (e.g., for capture, 3D rectification, etc.) with minimal to no intervention from human operators. Calibration drift and sensor errors can be also detected over time via accumulation of calibration results, enabling the ACVS 206 to determine whether a sensor is faulty, obscure, or otherwise failing relative to prior normal operation conditions. On-device co-opted testing for condition variance can also be provided, in which the ACVS 206 can communicatively couple with, and control, on-board lighting systems, navigation (movement) systems, and sonic capabilities to introduce variance (e.g., challenging conditions) in calibration tests. In cases where there exist fixed payloads for known docking/recharging stations (e.g., payloads provided by vendors of fleets with commercial docking/recharging stations), the fixed payloads may be utilized to validate the geometry of the environment (e.g., the docking/recharging station) and/or the expected performance of sensor(s), including by taking into account device type (e.g., the type of autonomous vehicle), sensor type, and/or docking/recharging station type.

It is to be understood and appreciated that, while, sensor testing, calibration/recalibration, and/or management is described as pertaining to autonomous mobile devices, such as a vehicles, drones, robots, etc., the same or similar techniques may be equally applied for other types of devices. For instance, XR devices, such as XR headsets or other related gear may generally be equipped with external, outward facing sensors (e.g., cameras) for building/rendering environment spaces. In one or more embodiments, various techniques described herein with respect to the ACVS 206 can be implemented in an XR device to facilitate testing and calibration/recalibration of such sensors. In a case where the XR device is associated with a stand or mount for storage, geometric model data associated with structural features of the stand/mount can be compared with sensor readings (e.g., over time) to detect sensor degradation/failure (e.g., similar to that described above with respect to steps 220, 222, 224, and/or 226). In a case where the XR device is mount-free (e.g., is not associated with a stand/mount), local environment geometry can be scanned by the sensor(s) during power-on(s) or shutdown(s) (e.g., upon the XR device detecting displacement of the XR device, such as when a user is picking up the XR device for use and/or upon the XR device detecting stowage of the XR device, such as when the user is putting down the XR device after use) and compared with prior scanned data, such as prior geometric model(s) generated based on data previously provided by the sensors or generated by other 3D scanning system(s).

FIG. 2E is a high-level functional block diagram of a system 250 functioning within, or operatively overlaid upon, the communications network 100 of FIG. 1 in accordance with various aspects described herein. As depicted in FIG. 2E, the system 250 may include an ACVS 250a, an environment 250b, sensors 250c, onboard actuators 250d, and a connected system 250e. In various embodiments, the system 250 may be similar to the system 200 of FIG. 2A. For example, the system 250 may perform functions similar to those described above with respect to the system 200 of FIG. 2A, such as the device 204 of FIG. 2A, the ACVS 206 of FIG. 2A, the associated sensor(s), and/or the central server/system described above with respect to FIG. 2A. Such functions may include some or all of the steps 220, 222, 224, and 226 described above with respect to FIG. 2A. In various embodiments, the ACVS 250a may correspond to the ACVS 206 described above with respect to FIG. 2A. For example, the ACVS 250a shown in FIG. 2E may be incorporated in, include, or otherwise be associated with the ACVS 206 of FIG. 2A.

In one or more embodiments, some or all of the operations of the system 250, such as operation(s) of the ACVS 250a, can be performed during delayed POST (256) (e.g., power-on or shutdown test). As shown in FIG. 2E, the ACVS 250a can (e.g., similar to that described above with respect to the ACVS 206 of FIG. 2A) be configured to identify a (e.g., new) persistent environment 250b (e.g., a recharging/docking/resting station or the like), collect (254) (e.g., initial) sensor readings, obtain 258 variance information for the environment 250b (e.g., time of day, duration of stay, in-motion process, detected lighting, etc.), and introduce (260) variance testing of sensors 250c in the environment 250b (e.g., by manipulating/controlling onboard actuators 250d). As also shown in FIG. 2E, the ACVS 250a can obtain (262) (e.g., via distribution by the connected system 250e) various data, such as geometric models generated by a manufacturer/provider of the environment 250b, geometric models generated based on data provided by sensors of other peer devices, information regarding known sensor anomalies in certain geographic regions where sensors are subjected to particular environmental conditions, updates/changes (270) to some or all of the foregoing or to other data (e.g., variance information or variance introduction instructions, POST conditions, etc.), and/or the like. The connected system 250e can obtain (e.g., sample) data regarding various environments, including the environment 250b. In one or more embodiments, the ACVS 250a may assess (266) sensor degradation/failure over time, and provide sensor data and/or information regarding such degradation/failure to the connected system 250e for repair/remediation purposes (268). In certain embodiments, a user of the ACVS 250a (e.g., or of the device 204) may additionally, or alternatively, be notified of sensor-related issues.

It is to be understood and appreciated that the quantity and arrangement of systems, sensors, actuators, and devices shown in FIG. 2A and/or FIG. 2E are provided as an example. In practice, there may be additional systems, sensors, actuators, and/or devices, or differently arranged systems, sensors, actuators, and/or devices than those shown in FIG. 2A and/or FIG. 2E. For example, the system 200 or 250 can include more or fewer systems, sensors, actuators, and/or devices. In practice, therefore, there can be hundreds, thousands, millions, billions, etc. of such systems, sensors, actuators, and/or devices. In this way, example system 200 or 250 can coordinate, or operate in conjunction with, a set of systems, sensors, actuators, and/or devices and/or operate on data sets that cannot be managed manually or objectively by a human actor. Furthermore, two or more systems, sensors, actuators, or devices shown in FIG. 2A and/or FIG. 2E may be implemented within a single system, sensor, actuator, or device, or a single system, sensor, actuator, or device shown in FIG. 2A and/or FIG. 2E may be implemented as multiple systems, sensors, actuators, or devices. Additionally, or alternatively, a set of systems, sensors, actuators, and/or devices of the system 200 or 250 may perform one or more functions described as being performed by another set of systems, sensors, actuators, and/or devices of the system 200 or 250.

FIG. 2F depicts an illustrative embodiment of a method 280 in accordance with various aspects described herein. In some embodiments, one or more process blocks of FIG. 2F can be performed by an ACVS, such as the ACVS 206 and/or the ACVS 250a. In some embodiments, one or more process blocks of FIG. 2F may be performed by another device or a group of devices separate from or including the ACVS 206 and/or the ACVS 250a, such as the system 200, the device 204, the system 250, the sensors 250c, the actuators 250d, the central server/system of FIG. 2A, and/or the connected system 250e. In various embodiments, a device may comprise a processing system including a processor, and a memory that stores executable instructions that, when executed by the processing system, facilitate performance of operations.

At 282, the method can include obtaining data provided by a sensor associated with an autonomous computer vision system (ACVS). For example, the ACVS 206 and/or the ACVS 250a can, in a manner similar to that described above, perform one or more operations that include obtaining data provided by a sensor associated with the ACVS 206 and/or the ACVS 250a.

At 284, the method can include, based on the obtaining the data provided by the sensor, performing an analysis of the data relative to other data, wherein the other data comprises prior data provided by the sensor, different data provided by a different sensor associated with the ACVS, certain data provided by a central system communicatively coupled to the device, or a combination thereof. For example, the ACVS 206 and/or the ACVS 250a can, in a manner similar to that described above, perform one or more operations that include, based on the obtaining the data provided by the sensor, performing an analysis of the data relative to other data, wherein the other data comprises prior data provided by the sensor, different data provided by a different sensor associated with the ACVS 206 and/or the ACVS 250a, certain data provided by a central system communicatively coupled to the device, or a combination thereof.

At 286, the method can include, responsive to the performing the analysis of the data, determining whether a particular criterion associated with the data is satisfied. For example, the ACVS 206 and/or the ACVS 250a can, in a manner similar to that described above, perform one or more operations that include, responsive to the performing the analysis of the data, determining whether a particular criterion associated with the data is satisfied.

At 288, the method can include performing an action relating to the sensor, the ACVS, or both, based on a determination that the particular criterion associated with the data is satisfied. For example, the ACVS 206 and/or the ACVS 250a can, in a manner similar to that described above, perform one or more operations that include performing an action relating to the sensor, the ACVS 206 and/or the ACVS 250a, or both the sensor and the ACVS 206/250a, based on a determination that the particular criterion associated with the data is satisfied.

In some implementations of these embodiments, one or more of the obtaining the data, the performing the analysis, the determining, and the performing the action are effected during power-on of the device or during a shutdown operation of the device.

In some implementations of these embodiments, one or more of the obtaining the data, the performing the analysis, the determining, and the performing the action are effected while the device is present in a particular environment, wherein the particular environment comprises a docking station, a recharging station, a parking location, or a combination thereof.

In some implementations of these embodiments, the performing the analysis comprises comparing the data and the other data.

In some implementations of these embodiments, the operations further comprise generating a geometric model based on the data, wherein the other data is associated with one or more other geometric models, and wherein the performing the analysis comprises comparing the geometric model and the one or more other geometric models.

In some implementations of these embodiments, the particular criterion comprises a threshold deviation between the data and the other data.

In some implementations of these embodiments, the determining whether the particular criterion associated with the data is satisfied is based on identifying changes or deviations in sensor data over time.

In some implementations of these embodiments, the operations further comprise causing a variance condition to be introduced, wherein one or more of the performing the analysis and the determining are effected based on the variance condition.

In some implementations of these embodiments, the causing the variance condition to be introduced comprises causing a lighting unit of the device or in an environment of the device to emit light, causing a structural component of the device or in the environment of the device to be displaced, or a combination thereof.

In some implementations of these embodiments, the action comprises, automatically calibrating or recalibrating the sensor; automatically outputting a user notification regarding an operating condition of the sensor or the ACVS; automatically providing information regarding the operating condition of the sensor or the ACVS to one or more of the central system, a manufacturer of the device, and a third-party provider associated with the central system; automatically ordering a replacement part; automatically scheduling for repair of the sensor or the ACVS; or a combination thereof.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In various embodiments, a non-transitory machine-readable medium can comprise executable instructions that, when executed by a processing system including a processor, facilitate performance of operations. The operations can comprise obtaining, over a communications network, a set of data associated with various sensors of a plurality of autonomous devices in a fleet of autonomous devices; receiving, over the communications network, particular data associated with a first sensor of a first autonomous device in the fleet of autonomous devices, wherein the first autonomous device is not included in the plurality of autonomous devices; comparing the set of data and the particular data to identify a deviation that satisfies a threshold; generating calibration information based on identifying a deviation that satisfies the threshold; and transmitting the calibration information to the first autonomous device for calibrating or recalibrating the first sensor.

In some implementations of these embodiments, the comparing is based on the various sensors being of a same type as the first sensor, the plurality of autonomous devices being of a same type as the first autonomous device, environments in which the plurality of autonomous devices operates corresponding to an environment in which the first autonomous device operates, or a combination thereof.

In some implementations of these embodiments, the set of data comprises a plurality of first geometric models each associated with a respective autonomous device of the plurality of autonomous devices, wherein the particular data comprises a second geometric model associated with the first autonomous device.

In some implementations of these embodiments, each autonomous device in the fleet of autonomous devices comprises an autonomous vehicle, an unmanned aerial vehicle (UAV), a robot assistant, or an Internet-of-Things (IoT) device.

In some implementations of these embodiments, one or more of the comparing, the generating, and the transmitting are performed in accordance with variance conditions associated with an environment of the first autonomous device.

In various embodiments, a method can comprise receiving, by a processing system including a processor, data from a sensor of an autonomous device, wherein the autonomous device comprises a computer vision system; responsive to the receiving the data, generating, by the processing system, a first geometric model based on the data from the sensor; performing, by the processing system, a comparison of the first geometric model and a second geometric model generated based on different data; based on the performing the comparison of the first geometric model and the second geometric model, determining, by the processing system, that a threshold difference, between a first portion of the first geometric model and a second portion of the second geometric model, is satisfied; and causing, by the processing system, an action relating to the sensor or the computer vision system to be performed based on the determining that the threshold difference is satisfied.

In some implementations of these embodiments, the different data is previously provided by the sensor, provided by a different sensor of the autonomous device, provided by one or more sensors of a second autonomous device via a central system that is communicatively coupled to the autonomous device and the second autonomous device, or provided by a manufacturer or provider of the autonomous device via the central system.

In some implementations of these embodiments, the method can further comprise receiving, by the processing system, additional data from one or more other sensors of the autonomous device, wherein the generating the first geometric model is further based on the additional data from the one or more other sensors of the autonomous device.

In some implementations of these embodiments, one or more of the receiving the data, the generating the first geometric model, the performing the comparison, the determining, and the causing the action to be performed are effected during a power-on self-test operation of the autonomous device or during a shutdown operation of the autonomous device.

In some implementations of these embodiments, one or more of the receiving the data, the generating the first geometric model, the performing the comparison, the determining, and the causing the action to be performed are effected while the autonomous vehicle is docking into or traveling out of a docking station, positioning into or positioning out of a recharging station, or positioning into or positioning out of a parking location.

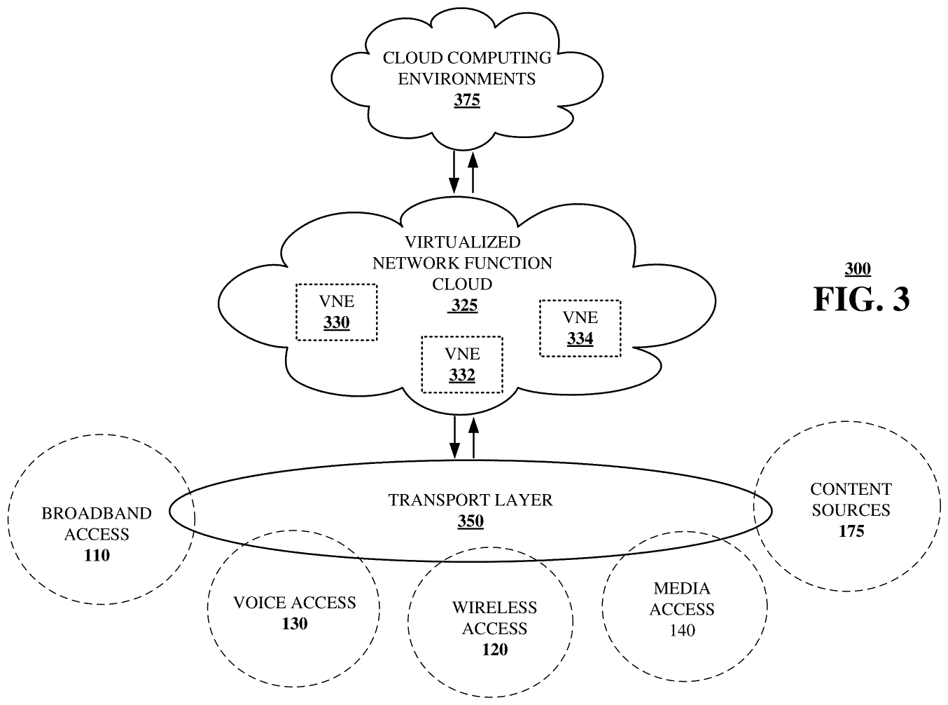

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of systems 200 and/or 250, and method 280 presented in FIGS. 1, 2A, 2E, and 2F. For example, virtualized communications network 300 can facilitate, in whole or in part, analysis of the performance of an autonomous computer vision system and/or associated sensor(s) over time, and facilitating calibration/recalibration/repair of the system and/or sensor(s) based on the analysis. In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

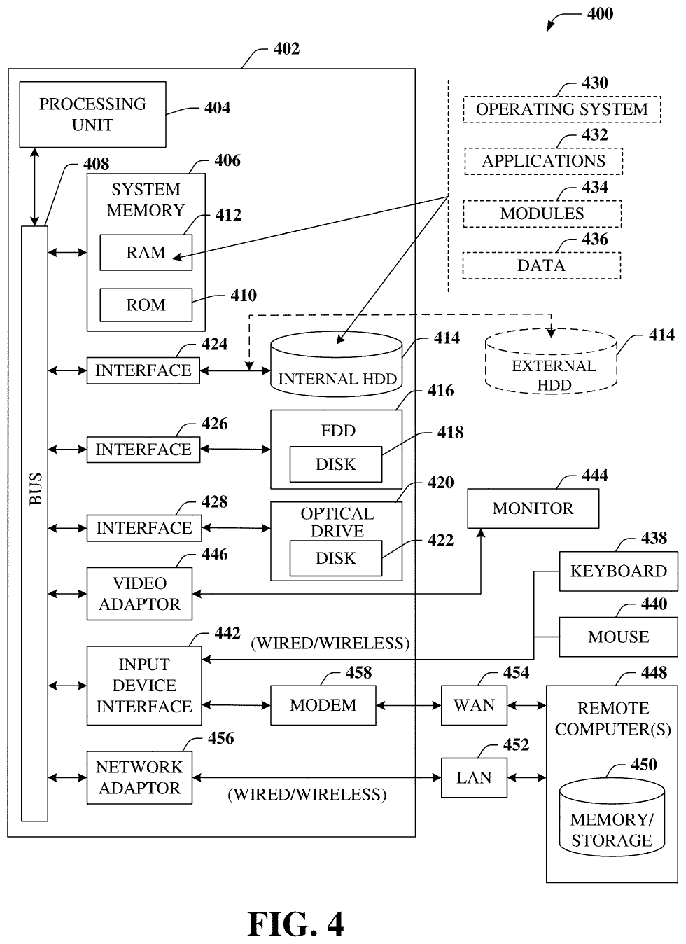

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, analysis of the performance of an autonomous computer vision system and/or associated sensor(s) over time, and facilitating calibration/recalibration/repair of the system and/or sensor(s) based on the analysis. Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

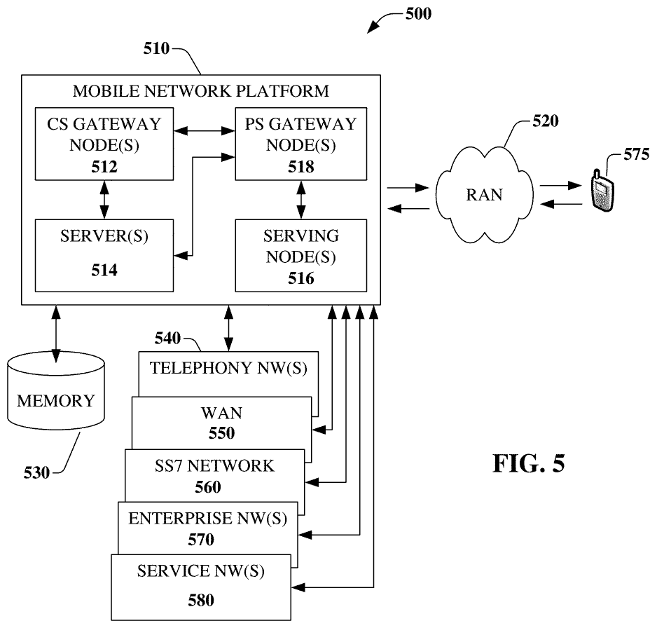

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, analysis of the performance of an autonomous computer vision system and/or associated sensor(s) over time, and facilitating calibration/recalibration/repair of the system and/or sensor(s) based on the analysis. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

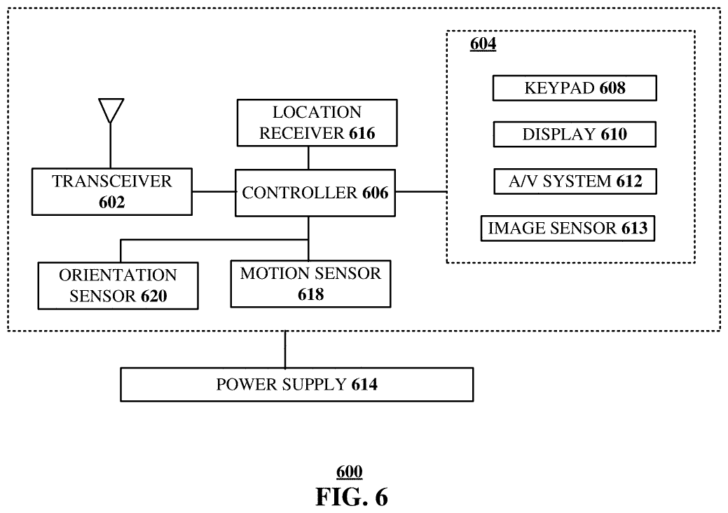

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate, in whole or in part, analysis of the performance of an autonomous computer vision system and/or associated sensor(s) over time, and facilitating calibration/recalibration/repair of the system and/or sensor(s) based on the analysis. The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a processing system including a processor; and
a memory that stores executable instructions that, when executed by the processing system, facilitate performance of operations, the operations comprising:
obtaining data provided by a sensor associated with an autonomous computer vision system (ACVS);
based on the obtaining the data provided by the sensor, performing an analysis of the data relative to other data, wherein the other data comprises prior data provided by the sensor, different data provided by a different sensor associated with the ACVS, certain data provided by a central system communicatively coupled to the device, or a combination thereof;
responsive to the performing the analysis of the data, determining whether a particular criterion associated with the data is satisfied; and
performing an action relating to the sensor, the ACVS, or both, based on a determination that the particular criterion associated with the data is satisfied, wherein the action comprises automatically calibrating or recalibrating the sensor, and wherein the operations are effected during docking of the device into a recharging station and during exiting of the device from the recharging station.

2. The device of claim 1, wherein one or more of the obtaining the data, the performing the analysis, the determining, and the performing the action are effected during power-on of the device or during a shutdown operation of the device.

3. The device of claim 1, wherein the recharging station comprises a challenge marker positioned thereon that, when detected by one or more sensors of the device, causes the device to download instructions from a provider of the recharging station for introducing variance to facilitate the calibrating or the recalibrating.

4. The device of claim 1, wherein the performing the analysis comprises comparing the data and the other data.

5. The device of claim 1, wherein the operations further comprise generating a geometric model based on the data, wherein the other data is associated with one or more other geometric models, and wherein the performing the analysis comprises comparing the geometric model and the one or more other geometric models.

6. The device of claim 1, wherein the particular criterion comprises a threshold deviation between the data and the other data.

7. The device of claim 1, wherein the determining whether the particular criterion associated with the data is satisfied is based on identifying changes or deviations in sensor data over time.

8. The device of claim 1, wherein the operations further comprise causing a variance condition to be introduced, and wherein one or more of the performing the analysis and the determining are effected based on the variance condition.

9. The device of claim 8, wherein the causing the variance condition to be introduced comprises causing a lighting unit of the device or in an environment of the device to emit light, causing a structural component of the device or in the environment of the device to be displaced, or a combination thereof.

10. The device of claim 1, wherein the action further comprises:
automatically outputting a user notification regarding an operating condition of the sensor or the ACVS;
automatically providing information regarding the operating condition of the sensor or the ACVS to one or more of the central system, a manufacturer of the device, and a third-party provider associated with the central system;
automatically ordering a replacement part;
automatically scheduling for repair of the sensor or the ACVS; or
a combination thereof.

11. A non-transitory machine-readable medium, comprising executable instructions that, when executed by a processing system including a processor, facilitate performance of operations, the operations comprising:
obtaining, over a communications network, a set of data associated with various sensors of a plurality of autonomous devices in a fleet of autonomous devices;
receiving, over the communications network, particular data associated with a first sensor of a first autonomous device in the fleet of autonomous devices, wherein the first autonomous device is not included in the plurality of autonomous devices;
comparing the set of data and the particular data to identify a deviation that satisfies a threshold;
generating calibration information based on identifying a deviation that satisfies the threshold; and
causing the first sensor to become calibrated or recalibrated by transmitting the calibration information to the first autonomous device, wherein the operations are performed during docking of the first autonomous device to a recharging station and during exiting of the first autonomous device from the recharging station.

12. The non-transitory machine-readable medium of claim 11, wherein the comparing is based on the various sensors being of a same type as the first sensor, the plurality of autonomous devices being of a same type as the first autonomous device, environments in which the plurality of autonomous devices operates corresponding to an environment in which the first autonomous device operates, or a combination thereof.

13. The non-transitory machine-readable medium of claim 11, wherein the set of data comprises a plurality of first geometric models each associated with a respective autonomous device of the plurality of autonomous devices, and wherein the particular data comprises a second geometric model associated with the first autonomous device.

14. The non-transitory machine-readable medium of claim 11, wherein each autonomous device in the fleet of autonomous devices comprises an autonomous vehicle, an unmanned aerial vehicle (UAV), a robot assistant, or an Internet-of-Things (IoT) device.

15. The non-transitory machine-readable medium of claim 11, wherein one or more of the comparing, the generating, and the transmitting are performed in accordance with variance conditions associated with an environment of the first autonomous device.

16. A method, comprising:
receiving, by a processing system including a processor, data from a sensor of an autonomous device, wherein the autonomous device comprises a computer vision system;
responsive to the receiving the data, generating, by the processing system, a first geometric model based on the data from the sensor;
performing, by the processing system, a comparison of the first geometric model and a second geometric model generated based on different data;
based on the performing the comparison of the first geometric model and the second geometric model, determining, by the processing system, that a threshold difference, between a first portion of the first geometric model and a second portion of the second geometric model, is satisfied; and
causing, by the processing system, an action relating to the sensor or the computer vision system to be performed based on the determining that the threshold difference is satisfied, wherein the action comprises automatically calibrating or recalibrating the sensor, and wherein the method is effected during docking of the autonomous device into a recharging station and during exiting of the autonomous device from the recharging station.

17. The method of claim 16, wherein the different data is previously provided by the sensor, provided by a different sensor of the autonomous device, provided by one or more sensors of a second autonomous device via a central system that is communicatively coupled to the autonomous device and the second autonomous device, or provided by a manufacturer or provider of the autonomous device via the central system.

18. The method of claim 16, further comprising receiving, by the processing system, additional data from one or more other sensors of the autonomous device, wherein the generating the first geometric model is further based on the additional data from the one or more other sensors of the autonomous device.

19. The method of claim 16, wherein one or more of the receiving the data, the generating the first geometric model, the performing the comparison, the determining, and the causing the action to be performed are effected during a power-on self-test operation of the autonomous device or during a shutdown operation of the autonomous device.

20. The method of claim 16, wherein the recharging station comprises a challenge marker positioned thereon that, when detected by one or more sensors of the autonomous device, causes the autonomous device to download instructions from a provider of the recharging station for introducing variance to facilitate the calibrating or the recalibrating.
